(19) United States
(12) Patent Application Publication
(10) Pub. No.: US 2020/0183670 A1
(43) Pub. Date: Jun. 11, 2020

(54) SYSTEM AND METHOD FOR TRANSFORMING COLD FUSION TECHNOLOGY ENVIRONMENT TO OPEN SOURCE ENVIRONMENT

(71) Applicant: Tech Mahindra Limited, Pune (IN)

(72) Inventors: Rajesh Kumar, New Delhi (IN); Poordhendu Chauhan, Uttar Pradesh (IN); Sundeep Dua, New Delhi (IN); Gaurav Sachdev, Uttar Pradesh (IN); Sandeep Agarwal, New Delhi (IN); Abhinav Rastogi, Uttar Pradesh (IN); Pratap Singh, Uttar Pradesh (IN); Subhrant Chhetri, Uttar Pradesh (IN)

(21) Appl. No.: 16/703,673

(22) Filed: Dec. 4, 2019

(30) Foreign Application Priority Data
Dec. 5, 2018 (IN) 201821045900

(51) Int. Cl. G06F 8/51; G06F 8/41; G06F 8/30

(52) U.S. Cl. CPC G06F 8/51; G06F 8/427; G06F 8/315; G06F 8/443; G06F 8/425

(57) ABSTRACT

A system and a method for transforming a cold fusion technology environment to an open source environment utilizes a comprehensive library that identifies and maps a source code to their corresponding open source equivalent using a collaboration of tokenizers and syntax analyzers. The system and the method significantly reduce overall total cost and time of conversion. The system and the method facilitate intrinsic bug-free code conversion. The system provides solutions that are easily utilized by any application irrespective of domain or industry.

### CROSS-REFERENCE TO RELATED APPLICATION(S)

This patent application relies for priority on and claims priority to Indian Patent Application No. 201821045900, filed on Dec. 5, 2018, the entire content of which is incorporated herein by reference.

### FIELD OF THE INVENTION

The present invention generally relates to transforming a computer related cold fusion technology platform environment and java based open source technology environment and more particularly, to a system and a method for transforming the cold fusion technology environment to the open source environment like Java.

### BACKGROUND OF THE INVENTION

Legacy proprietary technology platforms for development of a web application offer limited custom development and integration options. It is a challenge to maintain and administer highly distributed and expanding software assets and their licenses. It is even more important to move to open source technologies to lower IT expenses and introduce more flexibility.

Developers are often required to convert CFML (ColdFusion Markup Language) which is a proprietary technology environment to Java code environment. ColdFusion is an entirely different technology platform as compared to Java/JSP. ColdFusion require its own ColdFusion application server, webserver (IIS or apache) and ColdFusion specific installation kit whereas JSP/Java require JRE, JVM and any open source webserver. Hence, both technologies are entirely different. At present there is no standard product or solution readily available in the market to do the transformation from the proprietary technologies such as ColdFusion to open source such as Java.

Traditionally, engineers have to do manual re-write which includes modules, business logics, configurations and the like. This manual re-write has several shortcomings such as:
Huge cost, time and efforts to support the migration.
Manual rewrite requires extensive efforts to understand requirements and translate them to equivalent open source technologies.
Manual transformation process involves high risk of missing key requirements or introducing bugs which could turns out to be more costly at later stages.

Accordingly, there exists a need to provide a system and a method for enhanced demand estimation and sales automation that overcomes the above-mentioned drawbacks in the prior art.

### SUMMARY OF THE INVENTION

An object of the present invention is to save licensing cost of proprietary technologies.

Another object of the present invention is to achieve bug-free code conversion.

Accordingly, the present invention provides a system for transforming cold fusion technology environment to open source environment. The system comprises a file upload utility, a processing module, a code converter, a code optimizer, an analytic engine, a report generator and an application packager.

The file upload utility is used for uploading a proprietary source code. The processing module is operably connected to the file upload utility. The processing module includes a language tool and a tag recognizer.

The language tool is Another Tool for Language Recognition (ANTLR). The language tool includes a first tokenizer, a first syntax analyzer and a token library embedded therein.

The first tokenizer breaks the uploaded proprietary source code into tokens. The first syntax analyzer includes grammar rules configured therein. The first syntax analyzer is adapted to arrange the tokens as per the grammar rule. The token library contains mapping for each token extracted by the first tokenizer and the first syntax analyzer along with corresponding cold fusion tag.

The tag recognizer is operably connected to the language tool. The tag recognizer includes a second tokenizer, a second syntax analyzer and a database. The second tokenizer is proprietary to open source lexer and the second syntax analyzer is proprietary to open source parser. The second tokenizer processes the tokens as an input from the language tool and breaks an input stream of cold fusion characters into vocabulary symbols. The second syntax analyzer creates a node tree from the cold fusion token stream received from the second tokenizer on the basis of cold fusion tags/functions. The database includes a tag library. The tag library is a Java tag library that contains the mapping of each cold fusion tag and their corresponding Java equivalents.

The code converter converts the cold fusion tags to corresponding Java equivalent code. The code optimizer is adapted to optimize the converted source code. The analytic engine calculates priority and percentage of the tags. The report generator is operably connected to the code optimizer for reporting the translation of one technology to other technology. The application packager is operably connected to the code optimizer. The application packager is responsible for packaging of a core engine into a user-friendly application.

In another aspect, the present invention provides a method for transforming a cold fusion technology environment to an open source environment.

### BRIEF DESCRIPTION OF THE DRAWINGS

The objects and advantages of the present invention will become apparent when the disclosure is read in conjunction with the following figures, wherein:

FIG. 1 shows an architecture of a system for transforming a cold fusion technology environment to an open source environment, in accordance with the present invention; and

FIG. 2 shows a flowchart of a method for transforming a cold fusion technology environment to an open source environment, in accordance with the present invention.

### DETAILED DESCRIPTION OF THE INVENTION

The foregoing objects of the invention are accomplished, and the problems and shortcomings associated with prior art techniques and approaches are overcome, by the present invention described in the present embodiments.

In general aspect, the present invention provides a system and a method for transforming a cold fusion technology environment to an open source environment. More specifically, the system and the method facilitate the conversion of programming languages from a proprietor cold fusion technology to the open source platform environment like Java. The system utilizes a comprehensive library that identifies and maps source code to their corresponding open source equivalent using a collaboration of a tokenizer and a syntax analyzer.

Throughout the present invention certain terms are used to describe the invention. The meaning of these terms is explained below.

CFML: ColdFusion Markup Language. Web page markup language that allows a Web site developer to create pages with variable information (text or graphics) that is filled in dynamically (on the fly) in response to variables such as user input. Along with the usual Hypertext Markup Language (HTML) tags that determine page layout and appearance, the page creator uses CFML tags to bring in content based on the results of a database query or user input. CMFL is a proprietary language developed for use with ColdFusion.

ANTLR: Another Tool For Language Recognition. It reads a language description file called a grammar and generates a number of source code files and other auxiliary files. Internally this is done by Parser and Lexer. The present invention proposes changes to the Parser and Lexer logic of ANTLR required to accomplish conversion from ColdFusion to Java.

Token: Lexer breaks up an input stream of characters (ColdFusion, in this case) into vocabulary symbols for a Parser. These vocabulary symbols are technically called tokens.

Node: Parser uses Lexer rules to identify these tokens into grammatical constructs and creates a custom data structure for each token it encounters. This custom data structure is called as a Node in proprietary to open source (Prop2Op) paradigm. A parser creates a Node based on the ANTLR grammar.

Tree: Since a ColdFusion page consist of many Tags and functions in a single file, a lexer breaks it into tokens which are then transformed into Nodes by a parser. For the whole page to be represented properly without any loss of information, a recursive processing is required. The custom data structure supports this recursive processing,

Lexer: This reads an input character or byte stream (i.e. characters, binary data, etc.), divides it into tokens using patterns you specify, and generates a token stream as output. It can also flag some tokens such as whitespace and comments as hidden.

Parser: This reads a token stream (normally generated by a lexer), and matches phrases in your language via the rules (patterns) you specify, and typically performs some semantic action for each phrase (or sub-phrase) matched. Each match could invoke a custom action, write some text via String Template, or generate an Abstract Syntax Tree for additional processing.

The present invention now is illustrated with reference to the accompanying drawings, throughout which reference numbers indicate corresponding parts in the various figures. These reference numbers are shown in bracket in the following description.

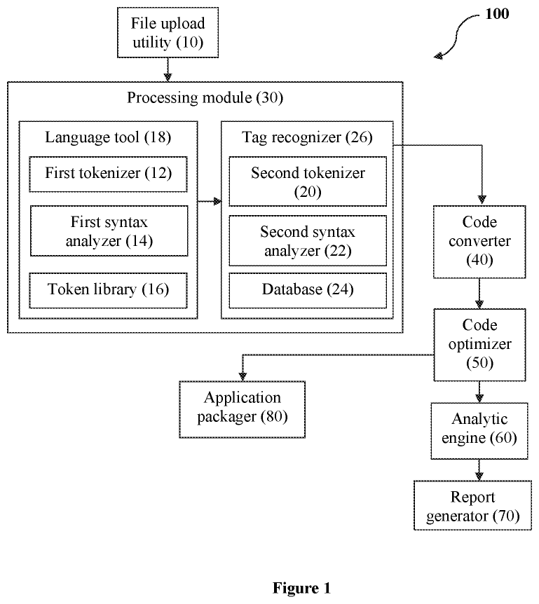

Referring to FIG. 1, a system (100) for transforming a cold fusion technology environment to an open source environment in accordance with the present invention is shown. Specifically, the system (100) is designed to automatically convert a proprietary technology such as ColdFusion technology to an open source technology like Java, JSP, Jython, Python and the like.

As shown in FIG. 1, the system (100) comprises a file upload utility (10), a processing module (30), a code converter (40), a code optimizer (50), an analytic engine (60), a report generator (70) and an application packager (80).

The file upload utility (10) is used to upload a proprietary source code. The processing module (30) is operably connected to the file upload utility (10). The processing module (30) includes a language tool (18) and a tag recognizer (26) embedded therein.

In an embodiment, the language tool (18) is Another Tool for Language Recognition (ANTLR). In the context of the present invention, ANTLR is the generic input receiver for all file extensions such as .cfm, .txt, .html, .jsp, and the like. The language tool (18) includes a first tokenizer (12) a first syntax analyzer (14) and a token library (16) embedded therein. The first tokenizer (12), for example a lexer, is adapted to break the uploaded proprietary source code into tokens. Specifically, the first tokenizer (12) is adapted to achieve seamless conversion of the tokens on the basis of tags and function priority.

The first syntax analyzer (14) includes program instructions/grammar rules configured therein. Specifically, the first syntax analyzer (14) includes a mapping grammar library specific to the cold fusion technology. The first syntax analyzer (14), for example a parser, is adapted to arrange the tokens as per the grammar rule. The token library (16) contains the mapping for each token extracted by the first tokenizer (12) and the first syntax analyzer (14) along with corresponding cold fusion tag.

In accordance with the present invention, both the first tokenizer (12) and the first syntax analyzer (14) work in conjunction such that the file input stream received by the file upload utility (10) is analysed by the language tool (18) to understand the context thereby distinguishing different tokens in the text using identifiers. The output from the language tool (18) is treated as an input to the tag recognizer (26).

The tag recognizer (26) is operably connected to the language tool (18). In an embodiment, the tag recognizer (26) is a cold fusion tag recognizer. The tag recognizer (26) includes a second tokenizer (20), a second syntax analyzer (22) and a database (24). In an embodiment, the second tokenizer (20) is proprietary to open source lexer (hereinafter “Prop2op-Lexer”) and the second syntax analyzer (22) is proprietary to open source parser (hereinafter, “Prop2op-Parser”).

The second tokenizer (20) is adapted to process tokens as an input from the language tool (18) specifically, from ALNTR. More specifically, the second tokenizer (20) recognizes cold fusion tokens and arranges these tokens into a proper manner. The second tokenizer (20) breaks up an input stream of cold fusion characters into vocabulary symbols for the second syntax analyzer (22). The second tokenizer (20) is also responsible for recognizing the cold fusion tags, either these are implemented in a proprietary to open source (Prop2Op) Java library or not, and helpful to generate a report.

The second syntax analyzer (22) applies a grammatical structure to the symbol stream received from the second tokenizer (20). The second syntax analyzer (22) is responsible for creating a structure/a node tree from the cold fusion token stream received from the second tokenizer (20) on the basis of cold fusion tags/functions. Specifically, the second tokenizer (20) and the second syntax analyzer (22) are adapted to construct a node tree hierarchy on the basis of cold fusion tags/functions to map the token (cold fusion tag/function) to corresponding Java tag/function equivalent. The tag recognizer (16) gets the equivalent Java code of the cold fusion source code from a Java library as per node tree structure generated by the second syntax analyzer (22). The second syntax analyzer (22) also recognizes parent and child relation details of processed tag.

In the context of the present invention, the second tokenizer (20) processes tokens for ColdFusion by understanding the syntax of ColdFusion language. For example, syntax is the rule that an identifier only use characters start with ‘<’ followed by ‘CF’—as long as it doesn't start with a number or any other characters.

The second tokenizer (20) accepts the sequence of characters “<CFSET” but rejects the characters “12dsadsa”. When seeing the valid text, the second tokenizer (20) may emit a token into the token stream such as IDENTIFIER (<CFSET).

The lexer has no concept of the structure or meaning of ColdFusion language.

Lexer's token don't contain any meaning

(LA (1) = = ’<’) && (LA (2) = = ’c’) && (LA (3) = = ’f’) &&
(LA (4) = = ’s’) && (LA (5) = = ’e’) && (LA (6) = = ’t’)

The second tokenizer (20) also recognizes the ColdFusion tags that are implemented in the Prop2Op Java library.

<cfcomponent output = “true” displayname = ‘GetRequestData’> <cffunction
name = “fngetEstimatorApproverDetails” access = “remote” output = “false” returnformat = “plain”
returntype = “any> <cfargument name = “estid” required = “true” type = “numeric” default = “1” />
<cfargument name = “Contractid” required = “true” type = “numeric” default = “1” /> <cfargument
name = “motid” required = “true” type = “numeric” default = “1” /> cfargument name = “appAreaCd”
required = “true” type = “string” default = “” /> <cfset var qExists = “”>
<cfinclude template = “..\settings.cfm”> <cfif listFind(Cookie.TestingFlow,Contractid,’,’)>

The second syntax analyzer (22) processes ColdFusion identifiers and syntax (semantics). The second syntax analyzer (22) is responsible for creating structure (node tree) from the “flat” token stream.

match(CFSET) ;
n = NodeFactory.createNode (“CfSet”);

For example, the second syntax analyzer (22) would further specify that token has a certain arrangement of tokens generated by the second tokenizer (20).

Code : <cfset var variable_name = ‘abc’>
And turn it into a token stream of
KEYWORD (CFSET) IDENTIFIER (VAR) IDENTIFIER (variable_name) OPERATOR (EQ)
OPERATOR_ASSIGNMENT STRING (‘abc’)

(whitespace in the lexer are ignored).

The second syntax analyzer (22) has a concept of the structure or meaning of ColdFusion language.

case CFSET:
{

{
match (CFSET) ;

The second syntax analyzer (22) is also responsible for enforcing the semantic rules of ColdFusion language for example, every tag must end with a ‘>’ characters.

match (ENDTAG) ;
}
break ;

The second syntax analyzer (22) is smart enough to recognize parent and child relation details of the processed tag.

e2=html (n) ;
e2.addParent (n) ;
n.addChild (e2) ;

The database (24) is a dynamic library file that includes a tag library embedded therein. In an embodiment, the tag library is a Java tag library that contains mapping of each cold fusion tag and their corresponding Java equivalents. Specifically, the database being a cold fusion tag library database lists all cold fusion tags with unique token number and the tag recognizer (26) recognizes these tokens during conversion of cold fusion code.

The code converter (40) is responsible for converting the cold fusion tags/functions to corresponding Java equivalent code. The code optimizer (50) is adapted to optimize the converted source code. The converted source code is optimized after matching with a predefined optimize construct.

The analytic engine (60) is responsible for calculating priority and percentage of the tags. Specifically, the analytic engine (60) identifies partially converted tags and determines the percentage of source code converted. Based on tag's impact on the overall code, the analytic engine (60) determines the priority of tags which need to be converted through human intervention.

The report generator (70) is operably connected to the code optimizer (50). The report generator (70) is responsible for reporting the translation of one technology to other technology. In an embodiment, the report is generated in a portable document format (PDF) as well as a user interface (UI) intensive web page well within a web application. However, it is understood here that the report can be generated in other suitable formats as per the intended application in other alternative embodiments of the system (100).

The application packager (80) is operably connected to the code optimizer (50). The application packager (80) is responsible for the packaging of a core engine into a user-friendly application that is used by an end user to convert his/her proprietary technology code into the open source technology easily and efficiently without having to indulge in the intricacies (internal functioning) of the core program.

In another aspect, the present invention provides a method for transforming a cold fusion technology environment to an open source environment. Specifically, the method is described herein below in conjunction with the system (100) of FIG. 1.

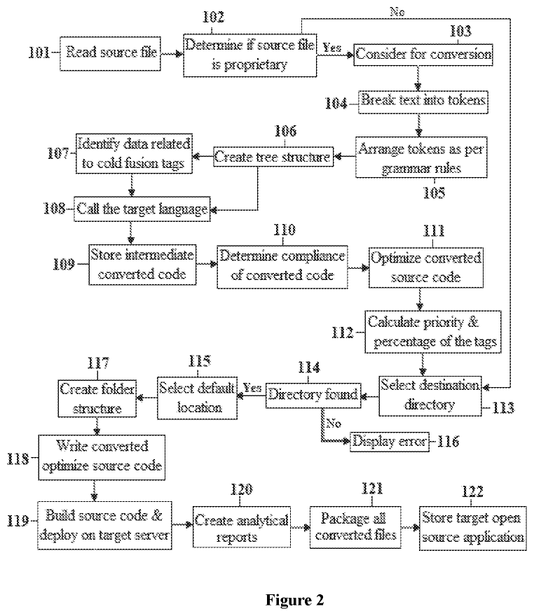

FIG. 2 shows the detailed flowchart illustrating the method for transforming the cold fusion technology environment to the open source environment in accordance with the present invention. In a first step (101), the method involves reading a source file. The source file having a proprietary source code is uploaded using the file upload utility (10). The language tool (18) reads the source file with the help of the first tokenizer (12) and the first syntax analyzer (14).

At step (102), the method involves determining if the source file is proprietary by determining the extension of the source file. The extension of the source file is determined by the language tool (18) specifically, ANTLR. If the extension of the source file is “.cfm” or “.cfc” then the file is considered for conversion at step (103) else the method moves to step (113).

At step (104), the method involves breaking text of the source file into tokens using the first tokenizer (12) for example lexer.

An exemplary code structure explaining breaking of text into tokens is described below:

ColdFusion source code

<cfset request_id = “999999”>
<cfset request_name = “Test Request”>

Lexer (after conversion using Lexer)

<cfset
request_name
=
“TestRequest”
>

Parser (After conversion using Parser)

<cfset request_name=“Test Request”>

At step (105), the method involves arranging the tokens as per grammar rules using the first syntax analyzer (14) for example parser. The first syntax analyzer (14) recognizes different tokens into meaningful keywords. Thereafter, the tokens are extracted on the basis of key and match with a predefined data. The predefined data in the context of the present invention means the lexer rules already defined in the lexer grammar. The first syntax analyzer (14) uses lexer rules in parsing through tokens and recognizing them.

An example of parser making use of lexer rules in parsing through tokens and recognizing them is described herein below.

### Example:

EQ: {tag}? ‘=’;

This is lexer rule and this is used by parser while identifying the token “=” and creating a custom data structure called as node for it and assigns a value “EQ” to it.

Tokens are extracted on the basis of key and match with already defined data related to ColdFusion tags and functions.

e.g switch ( LA(1)) {

case CFABORT:
case CFAPPLET:
case CFAPPLICATION:
case CFASSOCIATE:
case CFBREAK:

At step (106), the method involves creating a tree structure from a node using the tag library. The second syntax analyzer (22) creates a node tree from the cold fusion token stream received from the second tokenizer (20) on the basis of cold fusion tags/functions. The tree structure is created by maintaining parent child information and creating Java object using a factory design pattern in the tag recognizer (26).

In the context of the present invention, pseudo code of node is as explained below:

class Node {
Hashtable<String, Node> params;
private ArrayList<Node> children;
private ArrayList<Node> parents;
... ..}

As the node also contains children nodes, the tree like structure is formed wherein a complete ColdFusion page is traversed by just starting from the topmost root element into various branches and then leaf elements. If node element is tag then target language source code is extracted for selected tag else the method moves to step (108). If the node element created in the tree structure is a ColdFusion Tag, present in the tag library, it incurs that a corresponding open source equivalent mapping is present that can be extracted.

At step (107), the method involves identifying data related to cold fusion tags and functions. Once the tag is identified and match is found in the tag library, it means that a corresponding open source equivalent is available. In this step, the cold fusion tags and functions identified are converted to Java code equivalent. Thereafter, the method involves calling the target language at step (108).

At step (109), the method involves storing intermediate converted code in the code converter (40). At step (110), the method involves determining compliance of the converted code. Once the converted code is obtained, the code optimizer (50) analyzes the code to ensure that output is compliant with standard Java coding guidelines. The code optimizer (50) replaces all non-compliant snippets with optimized code snippet written in the tag and functions library (Prop2Op library). There are some already defined coding guidelines in Java, adhering to which one developer can make his/her code optimized. The method makes use of such coding guidelines and automates compliance with these guidelines through appropriate code snippet replacement into the node—processing part to make the code optimized in the true sense of the word.

At step (111), the method involves optimizing the converted source code using the code optimizer (50). The converted source code is optimized after matching with a predefined optimize construct.

At step (112), the method involves calculating priority and percentage of the tags by the analytic engine (60). At step (113), the method involves selecting a destination directory where target source code need to be converted. At step (114), the method involves determining whether the directory is found. If no directory found then default location is selected at step (115) else error message is displayed at step (116) and the method returns to step (101).

At step (117), the method involves creating a folder structure based on the target language. Each target language has a standard directory structure to house the source code. Thus, a similar empty directory structure with folders is created for Java.

At step (118), the method involves writing the converted optimize source code into a target file. All the optimized code files that are converted using Prop2Op are retrieved and placed in an appropriate folder path in the directory structure.

At step (119), the method involves building source code and deploying source code on a target server. The source code is built automatically using Maven build tool. Maven is a popular build tool for Java used to retrieve run time dependencies of the package. The output of the Java program is packaged in .war format. This .war file (packaged Java Code) is then deployed on the target server which hosts this application.

At step (120), the method involves creating analytical reports using report generator (70). The report is created based on fully converted, partially converted and not converted tags and function.

At step (121), the method involves packaging all converted files using the application packager (80). At final step (122), the method involves storing target open source application at a desired location.

Although primary use of the system (100) and the method is to convert proprietary CFML to Java, the system (100) and the method can also be extended for conversion from other proprietary technologies to open source technologies.

### ADVANTAGES OF THE INVENTION

Advantages of the invention include, but are not limited to, one or more of the following:
1. The system (100) enhances ANTLR capabilities by changing the way in which Parser and Lexer logic works.
2. The system (100) and the method significantly reduce overall total cost and time of conversion.
3. The system (100) utilizes a comprehensive library that identifies and maps a source code to their corresponding open source equivalent using a collaboration of the tokenizers (12, 20) and the syntax analyzers (14, 22).
4. The system (100) and the method facilitate intrinsic bug-free code conversion.
5. As the system (100) provides comprehensive code coverage, chances to miss requirements are minimal to none.
6. The system (100) provides solutions that are easily utilized by any application irrespective of domain or industry.
7. The system (100) and the method are adaptable with minimal change for different technologies.
8. After conversion of the source code to their corresponding open source equivalent, the system (100) intelligently detects and reports the percentage of successful conversion along with the gaps that need to be filled in manually.

The numerical values mentioned for the various physical parameters, dimensions or quantities are only approximations and it is envisaged that the values higher/lower than the numerical values assigned to the parameters, dimensions or quantities fall within the scope of the disclosure, unless there is a statement in the specification specific to the contrary.

The foregoing descriptions of specific embodiments of the present invention have been presented for purposes of illustration and description. They are not intended to be exhaustive or to limit the present invention to the precise forms disclosed, and obviously many modifications and variations are possible in light of the above teaching. The embodiments were chosen and described in order to best explain the principles of the present invention and its practical application, and to thereby enable others skilled in the art to best utilize the present invention and various embodiments with various modifications as are suited to the particular use contemplated. It is understood that various omissions and substitutions of equivalents are contemplated as circumstances may suggest or render expedient, but such omissions and substitutions are intended to cover the application or implementation without departing from the scope of the claims of the present invention.

What is claimed is:

1. A system for transforming a cold fusion technology environment to an open source environment, comprising:
a file upload utility for uploading a proprietary source code;
a processing module operably connected to the file upload utility, the processing module having
a language tool having
a first tokenizer embedded therein for breaking the uploaded proprietary source code into tokens,
a first syntax analyzer having grammar rules configured therein, the first syntax analyzer adapted to arrange the tokens as per the grammar rule, and
a token library containing mapping for each token extracted by the first tokenizer and the first syntax analyzer along with corresponding cold fusion tag, and
a tag recognizer operably connected to the language tool, the tag recognizer having
a second tokenizer for processing the tokens as an input from the language tool and for breaking an input stream of cold fusion characters into vocabulary symbols,
a second syntax analyzer for creating a node tree from the cold fusion token stream received from the second tokenizer on the basis of cold fusion tags/functions, and
a database having a tag library;
a code converter for converting the cold fusion tags to corresponding Java equivalent code;
a code optimizer adapted to optimize the converted source code;
an analytic engine for calculating priority and percentage of the tags;
a report generator operably connected to the code optimizer for reporting the translation of one technology to other technology; and
an application packager operably connected to the code optimizer, the application packager responsible for packaging of a core engine into a user-friendly application.

2. The system as claimed in claim 1, wherein the language tool is Another Tool for Language Recognition (ANTLR).

3. The system as claimed in claim 1, wherein the tag recognizer is a cold fusion tag recognizer.

4. The system as claimed in claim 1, wherein the second tokenizer is proprietary to open source lexer and the second syntax analyzer is proprietary to open source parser.

5. The system as claimed in claim 1, wherein the tag library is a Java tag library that contains the mapping of each cold fusion tag and their corresponding Java equivalents.

6. A method for transforming a cold fusion technology environment to an open source environment, comprising:
reading a source file, wherein a language tool reads the source file with the help of a first tokenizer and a first syntax analyzer, the first syntax analyzer having grammar rules configured therein;
determining an extension of the source file, wherein the extension of the source file is determined by the language tool;
breaking text of the source file into tokens using the first tokenizer;
arranging the tokens as per grammar rules using the first syntax analyzer;
creating a tree structure from a node using a tag library, wherein a second syntax analyzer creates a node tree from a cold fusion token stream received from a second tokenizer on the basis of cold fusion tags/functions;
identifying data related to cold fusion tags and functions;
calling the target language;
storing intermediate converted code in a code converter;
determining compliance of the converted code, wherein a code optimizer analyzes the code to ensure that output is compliant with standard Java coding guidelines;
optimizing the converted source code using the code optimizer;
calculating priority and percentage of the tags by an analytic engine;
selecting a destination directory where target source code needs to be converted;
creating a folder structure based on the target language;
writing the converted optimize source code into a target file;
building source code and deploying source code on a target server;
creating analytical reports using a report generator, wherein the report is created based on fully converted, partially converted and not converted tags and function;
packaging all converted files using an application packager; and
storing target open source application at a desired location.

7. The method as claimed in claim 6, wherein the language tool is Another Tool for Language Recognition (ANTLR).

8. The method as claimed in claim 6, wherein the language tool includes a token library that contains mapping for each token extracted by the first tokenizer and the first syntax analyzer along with corresponding cold fusion tag.

9. The method as claimed in claim 6, wherein the second tokenizer processes the tokens as an input from the language tool and breaks an input stream of cold fusion characters into vocabulary symbols.

10. The method as claimed in claim 6, wherein the second tokenizer is proprietary to open source lexer and the second syntax analyzer is proprietary to open source parser.

11. The method as claimed in claim 6, wherein the tree structure is created by maintaining parent child information and creating Java object using a factory design pattern in a tag recognizer.

12. The method as claimed in claim 11, wherein the tag recognizer is a cold fusion tag recognizer.

13. The method as claimed in claim 6, wherein the tag library is a Java tag library embedded in a database of the tag recognizer and contains the mapping of each cold fusion tag and their corresponding Java equivalents.
